(19) United States
(12) Patent Application Publication
(10) Pub. No.: US 2020/0333239 A1
(43) Pub. Date: Oct. 22, 2020

(54) PARTICULATE MATTER CONCENTRATION CALCULATING DEVICE AND METHOD

(71) Applicant: XL PHOTONICS, INC., Daejeon (KR)

(72) Inventor: Heungro CHOO, Daejeon (KR)

(21) Appl. No.: 16/755,402

(22) PCT Filed: Oct. 11, 2018
(86) PCT No.: PCT/KR2018/011934

§ 371 Date: Apr. 10, 2020

(30) Foreign Application Priority Data
Oct. 12, 2017 (KR) 10-2017-0132563

(51) Int. Cl. G01N 21/01; G01N 15/02

(52) U.S. Cl. CPC G01N 21/01; G01N 15/0205

(57) ABSTRACT

A particulate matter concentration calculating device and method is disclosed. An objective of an embodiment of the present invention is to provide a particulate matter concentration calculating device and method which, in order to allow individual measurement terminals employing a light scattering method to accurately measure particulate matter concentration, calculates a constant or constants required for correction of a concentration value measured by each of the measurement terminals, by using a standard particulate matter measurement device and a reference particulate matter measurement device.

### TECHNICAL FIELD

Embodiments of the disclosure relate to a device and method for precisely computing the concentration of particulate matter and providing values necessary for correcting the concentration of particulate matter measured by each individual measuring device.

### BACKGROUND ART

The description of the Discussion of Related Art section merely provides information that may be relevant to embodiments of the disclosure but should not be appreciated as necessarily constituting the prior art.

Particulate matter or particulate pollution recently draws public attention.

Particulate matter may cause a stroke, depression, migraine, cerebrovascular disease, eye inflammation or other eye disease, rhinitis or laryngitis, atopic dermatitis or other skin disease, asthma, lung disease or respiratory disease, arrhythmia, cardiac infarction, or chronic disease, or fetal growth retardation.

Thus, a need exists for precisely measuring and making public the concentration of particulate matter in the air. Gravimetric method, β-ray absorption method, and light scattering method are among conventional ways to do so.

Gravimetric methods take samples from a filter bed for a predetermined time and directly measure the mass of fine particles with a diameter of a predetermined size or less. PM10 represents the total weight of particulates which are 10 μm or less in diameter, and PM2.5 the total weight of particulates which are 2.5 μm or less in diameter.

β-rays are absorbed more when passing through a larger mass of material. β-ray absorption methods take advantage of such nature of the radiation. This methods measure the amount of β-rays absorbed by a filter bed from which fine particles have been sampled and obtain the concentration of the particulates from the measurements.

However, gravimetric methods, despite their accuracy, cannot give real-time measurements due to the need for sampling for a time for sampling which takes typically a few hours to 24 hours. β-ray absorption methods suffer from the same issues. That is, β-ray absorption also fails to calculate, in real-time, the concentration of particulate matter. Further, the methods require an expensive piece of equipment for measurement which may cost a few tens of thousands of dollars. For these reasons, particulate matter measurement is carried out in some specific areas, and the resultant measurements are used to estimate the concentration on other areas.

Light scattering methods measure the amount of light scattered on particulate matter and calculate the concentration of the particulate matter. Light scattering methods enable real-time measurement with a relatively low-cost device. Light scattering methods is an indirect method. Light scattering methods calculate the particulate matter concentration by measuring the average scattered light power, or by multiplying the size and number of fine particles with corresponding weight factors. The size and number of fine particles are calculated by measuring the variations in scattered light with the short time resolution (milli second, microsecond, or less). Since the variations in particulate matter compositions, which changes by the time of the day, season, and location, are not properly considered , the light scattering may fail to provide accurate results.

Thus, there are ongoing research efforts to accurately measure the weight of particulate matter using light scattering methods, but a difficulty still exists to provide accurate particulate matter concentration.

### DETAILED DESCRIPTION OF THE INVENTION

### Technical Problem

According to an embodiment of the present invention, there is provided a particulate matter concentration computing device and method that computes a constant or constants necessary for correcting the concentration measured by an individual measuring terminal, which uses a light scattering method, using a particulate matter standard measuring device or reference measuring device to allow the individual measuring terminal to measure an accurate particulate matter concentration.

According to an embodiment of the present invention, there is provided a particulate matter concentration computing device and method that gathers corrected particulate matter concentration measurements and location information from individual measuring terminals measuring the concentration of particulate matter in various locations and accumulate particulate matter concentration data per time, season, or place.

### Technical Solution

According to an embodiment of the present invention, a device of computing a concentration of particulate matter, providing a particulate matter correction constant to allow an individual measuring terminal measuring particulate matter using a light scattering method to measure an accurate particulate matter concentration, comprises a communication unit receiving a reference particulate matter concentration measurement from a reference measuring device having the same configuration as the individual measuring terminal or capable of identifying a quantitative correlation with a measurement from the individual measuring terminal, a standard particulate matter concentration measurement from a standard measuring device or the reference measuring device, and location information from the individual measuring terminal and transmitting the particulate matter correction constant to the individual measuring terminal and a controller computing the particulate matter correction constant using the reference particulate matter concentration measurement and the standard particulate matter concentration measurement and transmitting the computed particulate matter correction constant to the individual measuring terminal.

According to an embodiment of the present invention, the reference measuring device is placed within a preset range from the standard measuring device.

According to an embodiment of the present invention, the particulate matter concentration computing device further comprises a database storing respective identifiers and locations of the standard measuring device and the reference measuring device, with the identifiers matched with the locations.

According to an embodiment of the present invention, the database stores atmospheric or weather information in the locations of the standard measuring device and the reference measuring device, with the atmospheric or weather information matched with the respective identifiers of the standard measuring device and the reference measuring device.

According to an embodiment of the present invention, the communication unit receives the reference particulate matter concentration measurement or the standard particulate matter concentration measurement, along with an identifier of the reference measuring device or the standard measuring device, from the reference measuring device or the standard measuring device.

According to an embodiment of the present invention, a method of computing, by a particulate matter concentration computing device, a concentration of particulate matter, for providing a particulate matter correction constant to allow an individual measuring terminal measuring particulate matter using a light scattering method to measure an accurate particulate matter concentration, comprises receiving a reference particulate matter concentration measurement from a reference measuring device having the same configuration as the individual measuring terminal or capable of identifying a quantitative correlation with a measurement from the individual measuring terminal and a standard particulate matter concentration measurement from a standard measuring device or the reference measuring device, computing the particulate matter correction constant using the reference particulate matter concentration measurement and the standard particulate matter concentration measurement, and transmitting the computed particulate matter correction constant to the individual measuring terminal.

According to an embodiment of the present invention, the reference measuring device is placed within a preset range from the standard measuring device.

According to an embodiment of the present invention, the receiving receives the reference particulate matter concentration measurement or the standard particulate matter concentration measurement, along with an identifier of the reference measuring device or the standard measuring device, from the reference measuring device or the standard measuring device.

According to an embodiment of the present invention, the particulate matter concentration computing method further comprises storing respective identifiers and locations of the standard measuring device and the reference measuring device, with the identifiers matched with the locations.

According to an embodiment of the present invention, the storing stores atmospheric or weather information in the locations of the standard measuring device and the reference measuring device, with the atmospheric or weather information matched with the respective identifiers of the standard measuring device and the reference measuring device.

According to an embodiment of the present invention, a particulate matter measuring terminal measuring a concentration of particulate matter using a light scattering method, comprises a power unit supplying power to each component in the particulate matter measuring terminal, a communication unit receiving, from a particulate matter concentration computation server, a particulate matter concentration correction constant computed using a reference particulate matter concentration measurement from a reference measuring device having the same configuration as the particulate matter measuring terminal or capable of identifying a quantitative correlation with a measurement from the particulate matter measuring terminal and a standard particulate matter concentration measurement from a standard measuring device, a particulate matter measuring unit measuring the concentration of particulate matter using the light scattering method, and a controller computing an accurate particulate matter concentration by correcting the particulate matter concentration measured by the particulate matter measuring unit using the particulate matter concentration correction constant.

According to an embodiment of the present invention, the particulate matter measuring terminal further comprises a positioning unit measuring a location of the particulate matter measuring terminal to compute the particulate matter concentration correction constant using the standard measuring device and reference measuring device located closest to the particulate matter measuring terminal when the particulate matter concentration computation server computes the particulate matter concentration correction coefficient.

### Advantageous Effects

As described above, according to an embodiment of the present invention, the particulate matter concentration computing device computes a constant or constants necessary for correcting the concentration measured using the particulate matter standard measuring device or reference measuring device and may thus measure an accurate particulate matter concentration even when the individual measuring terminal uses a light scattering method.

According to an embodiment of the present invention, a particulate matter concentration computing device may gather corrected particulate matter concentration measurements and location information from individual measuring terminals measuring the concentration of particulate matter in various locations and accumulate particulate matter concentration data per time, season, or place, thereby accurately predicting the concentration of particulate matter per time, weather, or place.

According to an embodiment of the present invention, although a plurality of cards of the same kind are generated, the user may be allowed to select and use a card suitable for the context, and payment or charging may be performed using the selected card.

Further, according to an embodiment of the present invention, a target advertisement may be provided to a specific user who is to charge using a travel card, allowing the operator of card management system to create benefits.

### BRIEF DESCRIPTION OF DRAWINGS

FIG. 1 is a view illustrating a particulate matter concentration computation system according to an embodiment of the present invention;

FIG. 2 is a block diagram illustrating a configuration of a particulate matter concentration computation server according to an embodiment of the present invention;

FIG. 3 is a block diagram illustrating a configuration of a computation unit of an individual measuring terminal according to an embodiment of the present invention;

FIG. 4 is a block diagram illustrating a configuration of a particulate matter measuring unit of an individual measuring terminal according to an embodiment of the present invention;

FIG. 5 is a flowchart illustrating a method of computing the concentration of particulate matter by a particulate matter concentration computation server according to an embodiment of the present invention; and

FIG. 6 is a view illustrating a map where an individual measuring terminal and a standard measuring device according to an embodiment of the present invention.

### MODE TO PRACTICE THE INVENTION

Various changes may be made to the present invention, and the present invention may come with a diversity of embodiments. Some embodiments of the present invention are shown and described in connection with the drawings. However, it should be appreciated that the present disclosure is not limited to the embodiments, and all changes and/or equivalents or replacements thereto also belong to the scope of the present disclosure. Similar reference denotations are used to refer to similar elements throughout the drawings.

The terms “first” and “second” may be used to describe various components, but the components should not be limited by the terms. The terms are used to distinguish one component from another. For example, a first component may be denoted a second component, and vice versa without departing from the scope of the present disclosure. The term “and/or” may denote a combination(s) of a plurality of related items as listed or any of the items.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when a component is “directly connected to” or “directly coupled to” another component, no other intervening components may intervene therebetween.

The terms as used herein are provided merely to describe some embodiments thereof, but not to limit the present disclosure. As used herein, the singular forms “a,” “an,” and “the” are intended to include the plural forms as well, unless the context clearly indicates otherwise. As used herein, the term “comprise,” “include,” or “have” should be appreciated not to preclude the presence or addability of features, numbers, steps, operations, components, parts, or combinations thereof as set forth herein.

Unless otherwise defined, all terms including technical and scientific terms used herein have the same meaning as commonly understood by one of ordinary skill in the art to which the embodiments of the present disclosure belong.

It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 1 is a view illustrating a particulate matter concentration computation system according to an embodiment of the present invention.

Referring to FIG. 1, according to an embodiment of the present invention, a particulate matter concentration computation system 100 includes a standard measuring device 110, a reference measuring device 120, a particulate matter concentration computation server 130, and an individual measuring terminal 140. The particulate matter concentration computation system 100 may further include a standard concentration measurement storage server 115.

The standard measuring device 110 is a device that provides a standard concentration measurement of particulate matter (hereinafter, referred to as ‘standard particulate matter concentration measurement’) and provides an accurate particulate matter concentration during a specific time period. The standard measuring device 100 may be a measuring device in a particulate matter measuring center that is operated by the government and provides an accurate particulate matter concentration during a specific time period by a national standard measurement method, e.g., gravimetric or beta ray absorption method. However, as mentioned in the Background section, the standard measuring device 110 does not provide particulate matter concentration necessarily in real-time.

The standard measuring device 110 transmits the measured standard particulate matter concentration to the standard concentration measurement storage server 115, the particulate matter concentration computation server 130, or the reference measuring device 120. The standard measuring device 110 may transmit its identifier along with the measured standard particulate matter concentration, to the particulate matter concentration computation server 130 to allow the particulate matter concentration computation server 130 to identify what standard measuring device has transmitted the measured concentration.

The reference measuring device 120 is a measuring device that has the same configuration as the individual measuring terminal 140 or may identify a quantitative correlation with the value measured by the individual measuring terminal 140. The reference measuring device 120 measures the concentration of particulate matter within a preset range of the standard measuring device 110 and provides a reference particulate matter concentration measurement (hereinafter, referred to as ‘reference particulate matter concentration measurement’). The reference measuring device 120 is placed within a preset range of the standard measuring device 110 and measures the concentration of particulate matter in the air in nearly the same place as the standard measuring device 110. The reference measuring device 120 may have the same configuration as the individual measuring terminal 140 and measure the concentration of particulate matter in the air in the same manner as the individual measuring terminal 140. For example, the reference measuring device 120 may measure the concentration of particulate matter using a light scattering method, by multiplying the same weight coefficient as that of the individual measuring terminal 140. However, the reference measuring device 120 need not necessarily have the same sensor configuration as the individual measuring terminal 140. If a quantitative correlation between the measurement from the reference measuring device 120 and the measurement from the individual measuring terminal 140 can be set up, constants necessary for correcting the concentration of particulate matter may be computed from the results of measurement by the standard measuring device 110, the reference measuring device 120, and the individual measuring terminal 140.

The reference measuring device 120 transmits the measured reference particulate matter concentration to the particulate matter concentration computation server 130. The reference measuring device 120 may transmit its identifier or its location along with the measured reference particulate matter concentration to the particulate matter concentration computation server 130. Thus, the particulate matter concentration computation server 130 may figure out the standard measuring device around which the reference measuring device has measured the received reference particulate matter concentration. Upon receiving the standard particulate matter concentration measurement from the standard measuring device 110, the reference measuring device 120 may transmit the standard particulate matter concentration measurement along with the reference particulate matter concentration measurement and identifier or location information, to the particulate matter concentration computation server 130.

The particulate matter concentration computation server 130 receives the standard particulate matter concentration measurement and the reference particulate matter concentration measurement from the standard measuring device 110, a standard concentration measurement storage server 115, or the reference measuring device 120 and computes a constant or constants (hereinafter, referred to as “concentration correction constant’) necessary for correcting the particulate matter concentration measurement. As described above, the standard particulate matter concentration measurement is the concentration of particulate matter in the air measured using an accurate particulate matter concentration measurement method by the standard measuring device 110. Meanwhile, the reference measuring device 120 is a device that is the same as the individual measuring terminal 140 or may identify a quantitative correlation with the measurement from the individual measuring terminal 140, and the reference measuring device 120 measures the concentration of particulate matter in the air in substantially the same place as the standard measuring device 110 although less accurately measuring the particulate matter concentration. Thus, the particulate matter concentration computation server 130 may compute the difference between the standard particulate matter concentration measurement and the reference particulate matter concentration measurement, thereby identifying an error in the concentration of particulate matter measured by the individual measuring terminal 140 from the actual concentration of particulate matter. The particulate matter concentration computation server 130 computes the difference between the standard particulate matter concentration measurement and the reference particulate matter concentration measurement and provides concentration correction coefficient necessary for conversion into accurate particulate matter weight to the individual measuring terminal 140. Thus, the individual measuring terminal 140 may obtain the accurate particulate matter concentration. The particulate matter concentration computation server 130 computes the concentration correction coefficients in the specific location where the individual measuring terminal 140 has performed measurement and provides the concentration correction coefficients to the individual measuring terminal 140 so that the individual measuring terminal 140 is able to measure the accurate concentration although using a light scattering method. In computing the concentration of particulate matter using a light scattering method, the individual measurement device itself may not predict an accurate weight coefficient depending on time and place. Thus, the individual measuring terminal 140 may accurately measure the particulate matter concentration by applying the difference between the accurate particulate matter concentration measured by a standard measuring method and the particulate matter concentration measured by a light scattering method. Separately from this, the particulate matter concentration computation server 130 receives location information about each individual measuring terminal from each individual measuring terminal. The particulate matter concentration computation server 130 stores the location information about each individual measuring terminal and transmits concentration correction coefficients obtained from the standard measuring device and reference measuring device located closest to each individual measuring terminal to the individual measuring terminals.

Currently, a national organization (standard measuring terminal) provides particulate matter concentration data every predetermined time (e.g., every hour). Since the amount of particulate matter in the air does not drastically vary within a predetermined time, correction of the particulate matter concentration measured by the individual measuring terminal using the data from the national organization (standard measuring terminal) may provide substantially real-time, accurate particulate matter concentration measurements despite using a light scattering method that is relatively less accurate.

After transmitting the concentration correction coefficient to each individual measuring terminal, the particulate matter concentration computation server 130 receives a corrected particulate matter concentration measurement from each individual measuring terminal. The particulate matter concentration computation server 130 receives the corrected particulate matter concentration measurements from the individual measuring terminals that have transmitted the location information and requested correction coefficients and may thus identify the corrected, accurate particulate matter concentration measurement in each location and match it to each location, and store it. By continuously receiving and storing the corrected, accurate particulate matter concentration measurement in each location, the particulate matter concentration computation server 130 may form bigdata for particulate matter concentration measurements for each region. Using the bigdata, the particulate matter concentration computation server 130 may grasp the trend of particulate matter concentration measurements per place, time, or season and, if the data is accumulated, may provide more accurate measurements and concentration correction values. Or, the particulate matter concentration computation server 130 may receive non-corrected particulate matter concentration measurements from each individual measuring terminal. The particulate matter concentration computation server 130 stores the received non-corrected particulate matter concentration measurements and concentration correction coefficients, thereby providing the same effects as those described above.

The individual measuring terminal 140 transmits the location information to the particulate matter concentration computation server 130 to request a concentration correction coefficient and receives a concentration correction coefficient from the particulate matter concentration computation server 130. The individual measuring terminal 140 transmits its location information to the particulate matter concentration computation server 130 so that the particulate matter concentration computation server 130 may provide the concentration correction coefficient using the standard measuring device closest to the individual measuring terminal 140. The individual measuring terminal 140 receives the concentration correction coefficient which has been computed, with the location information applied, from the particulate matter concentration computation server 130.

The individual measuring terminal 140 measures the number of fine particles in the air using a particulate matter measuring unit 148 and then measures the concentration of particulate matter using a computation unit 144 and corrects the measured concentration using the concentration correction coefficient. The particulate matter measuring unit 148 measures the number of fine particles in the air using a light scattering method, and the computation unit 144 measures the concentration of particulate matter in the air using the weight factor. The computation unit 144 corrects the particulate matter concentration using the concentration correction coefficient received from the particulate matter concentration computation server 130, thereby computing the accurate particulate matter concentration. Thereafter, the individual measuring terminal 140 feeds the computed particulate matter concentration back to the particulate matter concentration computation server 130. Meanwhile, separately from computing the particulate matter concentration, the individual measuring terminal 140 may feed back non-corrected particulate matter concentration to the particulate matter concentration computation server 130 in feeding back the particulate matter concentration to the particulate matter concentration computation server 130.

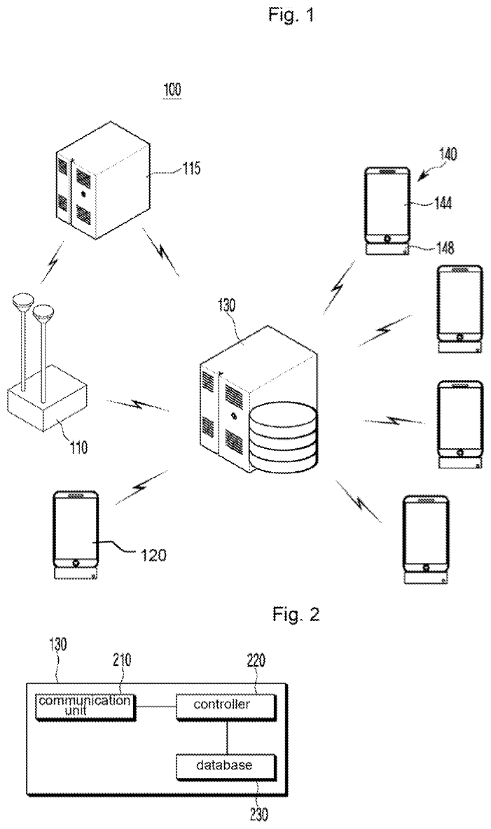

FIG. 2 is a block diagram illustrating a configuration of a particulate matter concentration computation server according to an embodiment of the present invention.

Referring to FIG. 2, according to an embodiment of the present invention, the particulate matter concentration computation server 130 includes a communication unit 210, a controller 220, and a database 230.

The communication unit 210 receives the location information from the individual measuring terminal 140, the reference particulate matter concentration measurement from the reference measuring device 120, and the standard particulate matter concentration measurement from the standard measuring device 110 or the standard concentration measurement storage server 115. The communication unit 210 is connected with the standard measuring device or individual measuring terminal (including the reference measuring device) via various wireless communication means, such as Wibro, WiMAX, Wi-Fi, Bluetooth, Zigbee, 4G or 5G, or wired communication means. In some cases, the communication unit 210 may receive the standard particulate matter concentration measurement directly from the standard measuring device 110 or the standard particulate matter concentration measurement, along with the reference particulate matter concentration measurement, from the reference measuring device 120. Further, the communication unit 210 may receive the identifier of the standard measuring device 110, along with the standard particulate matter concentration measurement, from the standard measuring device 110 or may receive the identifier or location of the reference measuring device 120, along with the reference particulate matter concentration measurement, from the reference measuring device 120.

The communication unit 210 transmits the concentration correction coefficient to the individual measuring terminal 140 and receives a corrected particulate matter concentration or a prior-correction particulate matter concentration, depending on initial settings of the individual measuring terminal 140, from the multiple 140.

The controller 220 selects the standard measuring device 110 and reference measuring device 120 which are closest to the individual measuring terminal 140 using the location information about the individual measuring terminal 140 and computes the concentration correction coefficient using the concentration measurements received from the selected standard measuring device 110 and reference measuring device 120. The controller 220 selects the standard measuring device 110 and reference measuring device 120 which are closest to the individual measuring terminal 140 using the identifiers and location information of the standard measuring device 110 and reference measuring device 120 stored in the database 230. The controller 220 computes the concentration correction coefficient using a difference between the reference particulate matter concentration measurement and the standard particulate matter concentration measurement received from the selected standard measuring device 110 and reference measuring device 120. For example, if the standard particulate matter concentration measurement is 10 μg, and the reference particulate matter concentration measurement is 20 μg, the controller 220 may set −50% as the concentration correction coefficient.

Thus, according to an embodiment, the particulate matter concentration computation server 130 may precisely perform correction on particulate matter measurements by simplified computation. The controller 220 controls the communication unit 210 to transmit the computed concentration correction coefficient to each individual measuring terminal 140 that has transmitted the location information.

In selecting the standard measuring device 110 and the reference measuring device 120 for computing the concentration correction coefficient, the controller 220 may select the closest devices to the individual measuring terminal 140 or may select most appropriate devices considering location information and atmospheric or weather information. First, the controller 220 selects standard measuring devices and reference measuring devices located within a preset radius of the location of the individual measuring terminal. Then, the controller 220 considers atmospheric or weather information in the locations of each standard measuring device and each reference measuring device among the standard measuring devices and reference measuring devices stored in the database 230. The atmospheric or weather information includes wind direction, wind speed, temperature, humidity, ozone concentration, sulfur dioxide concentration, carbon dioxide concentration, nitric oxide concentration, and volatile organic compound (VOC) concentration. The controller 220 identifies the particulate matter concentration, such as ozone concentration, sulfur dioxide concentration, carbon dioxide concentration, nitric oxide concentration, or VOC concentration, in the locations of each selected standard measuring device and each selected reference measuring device and selects only standard measuring devices and reference measuring devices for which the particulate matter concentration is a preset reference value or more. This is why if the measured particulate matter concentration is too low, then the computed concentration correction coefficient may be drastically changed even with a tiny measurement error in the standard measuring device or reference measuring device. Thus, the controller 220 selects only standard measuring devices and reference measuring devices for which the particulate matter concentration in their locations is a preset reference value or more among the selected standard measuring devices and selected reference measuring devices. Thereafter, the controller 220 selects the most appropriate standard measuring device and reference measuring device considering the location, wind direction, and wind speed of the individual measuring terminal. Selecting the most appropriate standard measuring device and reference measuring device considering the location, wind direction, and wind speed of the individual measuring terminal is described below with reference to FIG. 6.

FIG. 6 is a view illustrating a map where an individual measuring terminal and a standard measuring device according to an embodiment of the present invention.

There is an individual measuring terminal 140 to measure the concentration of particulate matter, and two standard measuring devices 110-1 and 110-2 are located around the individual measuring terminal 140. The standard measuring device 110-2 which is positioned in the east is closer to the individual measuring terminal 140. The controller 220 may provide a concentration correction value using the standard measuring device 110-2. However, in the context where yellow dust originating from China located more west than the individual measuring terminal 140 flies in over the westerlies, the result may vary. The standard measuring device 110-1 located relatively in the west, although farther from the individual measuring terminal 140, may provide more accurate concentration measurements than the standard measuring device 110-2 located relatively in the east, closer to the individual measuring terminal 140. Thus, in the above-described context, the controller 220 may provide a concentration correction value using the standard measuring device 110-1.

As such, the controller 220 may select the most appropriate standard measuring device and reference measuring device considering the location, particulate matter concentration, wind direction, and wind speed. The controller 220 may compute a concentration correction coefficient using the concentration measurements received from the selected standard measuring device 110 and reference measuring device 120.

Alternatively, in computing the concentration correction coefficient, the controller 220 may select multiple, rather than a single one, standard measuring devices and reference measuring devices and use the concentration measurements from each standard measuring device and each reference measuring device. The controller 220 may use all of the standard measuring devices and reference measuring devices which are located within a preset radius of the individual measuring terminal 140 and where the measured particulate matter concentration exceeds a preset reference value in computing the concentration correction coefficient, without further selection. Although the individual measuring terminal and the reference measuring device have the same configuration or may identify a quantitative correlation, each measuring device may have an error in measurement. Thus, if the controller 220 computes the concentration correction coefficient using one standard measuring device and one reference measuring device, the computed concentration correction coefficient may have a reduced accuracy depending on the measurement errors in the individual measuring terminal and the reference measuring device. To reduce such a chance, the controller 220 may use all of the standard measuring devices and reference measuring devices that meet a predetermined condition in computing each concentration correction coefficient and may average the computed concentration correction coefficients, thereby obtaining the final concentration correction coefficient to be provided to the individual measuring terminal. For example, if all of the standard measuring devices and reference measuring devices located in three points are selected as meeting a predetermined condition, and the concentration correction coefficient computed from the concentration measurements by the standard measuring device and reference measuring device located in point A is 50%, the concentration correction coefficient computed in point B is 30%, and the concentration correction coefficient computed in point C is 40%, the controller 220 may compute 40% as the final concentration correction coefficient to be provided to the individual measuring terminal.

Depending on contexts (e.g., when the wind direction and wind speed are high), the controller 220 may select the most appropriate standard measuring device and reference measuring device considering all of the location, particulate matter concentration, wind direction, and wind speed or may select one or more standard measuring devices and reference measuring devices considering the location and particulate matter concentration. The controller 220 calculates the concentration correction coefficient using the concentrations measured by the selected standard measuring device and reference measuring device.

The controller 220 may grasp the trend of concentration measurements depending on, e.g., place, time, and date, using the corrected particulate matter concentration and location received from the individual measuring terminal 140. To provide a more accurate corrected particulate matter concentration using bigdata, the controller 220 controls the database 230 to cumulatively store the corrected particulate matter concentrations received from the individual measuring terminal 140. The controller 220 may figure out the trend of concentration measurements using the particulate matter concentrations stored in the database 230. The controller 220 may provide the most appropriate particulate matter concentration correction coefficient to the individual measuring terminal based on weather data provided from a weather service center and self-measured data. By collecting, storing, and analyzing corrected particulate matter concentrations from myriad individual measuring terminals which are different in time, weather, and place, the controller 220 may grasp the trend of particulate matter concentrations depending on times, the weather, and places, and may properly compute the concentration correction coefficient.

The database 230 stores the identifiers and locations of the standard measuring device and reference measuring device and location information received from the individual measuring terminal. The database 230 previously stores the identifiers and locations of the standard measuring device and reference measuring device. Thus, if the individual measuring terminal 140 transmits the location information for requesting to correct the concentration, the database 230 allows the controller 220 to grasp the standard measuring device 110 or reference measuring device 120 located closest to the individual measuring terminal 140. Further, if the standard measuring device 110 or reference measuring device 120 transmits the standard particulate matter concentration measurement or reference particulate matter concentration measurement, the database 230 allows the controller 220 to identify the standard measuring device 110 or reference measuring device 120 that has transmitted the measurement. Further, to allow the controller 220 to grasp the individual measuring terminal that has requested to correct the particulate matter concentration and identify the standard measuring device and reference measuring device closer to the individual measuring terminal, the database 230 stores the location information received from the individual measuring terminal.

The database 230 may store the atmospheric or weather information in the location of the standard measuring device, reference measuring device, or individual measuring terminal, with the atmospheric or weather information matched with the location information about the standard measuring device, reference measuring device, or individual measuring terminal. The database 230 receives the atmospheric or weather information in the location of the standard measuring device, reference measuring device, or individual measuring terminal from an external device, such as of a weather service center, and stores the received atmospheric or weather information, with the atmospheric or weather information matched with the location information about the standard measuring device, reference measuring device, or individual measuring terminal. The atmospheric or weather information includes wind direction, wind speed, temperature, humidity, ozone concentration, sulfur dioxide concentration, carbon dioxide concentration, nitric oxide concentration, and volatile organic compound (VOC) concentration.

Further, the database 230 stores the location information received from the individual measuring terminal and the particulate matter concentrations corrected according to settings or non-corrected particulate matter concentrations. The database 230 stores myriad pieces of location information and corrected particulate matter concentrations received from individual measuring terminals, matches the location information and corrected particulate matter concentrations with the dates and times of reception, and stores them. Thus, the controller 220 may figure out the trend of concentration measurements using the information stored in the database 230.

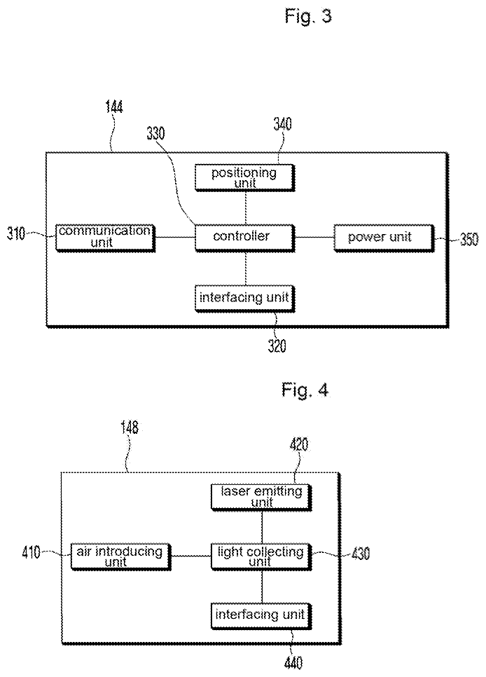

FIG. 3 is a block diagram illustrating a configuration of a computation unit of an individual measuring terminal according to an embodiment of the present invention.

Referring to FIG. 3, according to an embodiment of the present invention, a computation unit 144 of an individual measuring terminal includes a communication unit 310, an interfacing unit 320, a controller 330, a positioning unit 340, and a power unit 350.

The communication unit 310 transmits location information obtained by the positioning unit 340 to the particulate matter concentration computation server 130 or receives a concentration correction coefficient from the particulate matter concentration computation server 130.

The interfacing unit 320 connects the computation unit 144 with the particulate matter measuring unit 148. The interfacing unit 320 is implemented in various ways, such as IDE (Integrated Device Electronics), SATA (Serial Advanced Technology Attachment), SCSI (Small Computer System Interface), eSATA (External SATA), PCMCIA (Personal Computer Memory Card International Association), or USB (Universal Serial Bus) and connects the computation unit 144 with the particulate matter measuring unit 148.

The controller 330 receives the particulate matter concentration from the particulate matter measuring unit 148 via the interfacing unit 320 and corrects the particulate matter concentration received from the particulate matter measuring unit 148 using a concentration correction coefficient received from the particulate matter concentration computation server 130. The controller 330 may receive the particulate matter measurement from the particulate matter measuring unit 148 to compute the particulate matter concentration or may allow the measuring unit directly to compute the particulate matter concentration using a weight factor of a preset constant, for conversion into the particulate matter concentration (weight) and receive the computed concentration and correct the concentration using the correction constant. The particulate matter measuring unit 148 uses a light scattering method in particulate matter measurement. The light scattering method measures scattered light and computes the concentration of particulate matter. The strength of light scattered varies depending on the kind, concentration, size, light absorbing elements (e.g., black carbon) or humidity of the particulate matter. Further, since the weight factors preset in the measuring device may not reflect all of the above-enumerated factors per kind of particulate matter and are thus comprehensively determined under the assumption of a predetermined condition (e.g., assumed to be Arizona dust), the measurement of light scattered by particulate matter, itself, may not be computed into an accurate particulate matter concentration (or weight). To correct such inaccuracy, the controller 330 corrects the particulate matter concentration using the concentration measurement received from the particulate matter measuring unit 148. Since the concentration correction coefficient is computed using an error between the result measured by the standard measuring device 110 and the result measured by the reference measuring device that has the same configuration as the individual measuring terminal 140 or may identify a quantitative correlation with the measurement of the individual measuring terminal 140, the controller 330 may provide an accurate particulate matter concentration measurement result by correction using the concentration correction coefficient.

The computation unit 144 may provide an accurate particulate matter concentration measurement result quickly and in a simplified manner although using a light scattering method.

The computation unit 144 uses the concentration correction coefficient received from the particulate matter concentration computation server 130 and thus need not include a separate complicated algorithm or additional component for raising the accuracy of results measured by the light scattering method (by the particulate matter measuring unit 148) which is a relatively inaccurate measurement method than the other national standard measurement methods, such as the gravimetric method or beta ray absorption measurement method. By eliminating the need for performing processing by a separate algorithm or additional configuration, the computation unit 144 may correct the inaccurate measurement results obtained by the particulate matter measuring unit 148 and provide accurate measurement results substantially in real-time and need not consume additional costs for equipping a separate algorithm or additional component.

Further, since the computation unit 144 corrects the results measured by a typical light scattering method using the correction constant, the particulate matter measuring unit 148 is not required to have a separate algorithm or additional component for enhancing the particulate matter concentration measurement results. Thus, the computation unit 144 may provide accurate particulate matter concentration measurement results without causing compatibility issues, even when combined with any light scattering-based particulate matter measuring unit. The computation unit 144 may compute the particulate matter concentration in an accurate and simplified manner even using a light scattering method that may be implemented relatively in low costs as compared with the other particulate matter measurement methods.

The positioning unit 340 measures the location of the individual measuring terminal 140 which is to be transmitted to the particulate matter concentration computation server 130. The positioning unit 340 measures the location of the individual measuring terminal 140 using various schemes, such as a network-based scheme that software-wise identifies the location of the terminal using the radio wave environment of relaying devices, a handset-based scheme that identifies the location of the terminal using a global positioning system (GPS) receiver equipped in the terminal, and a scheme of identifying the terminal by combining the network-based scheme and the handset-based scheme.

The power unit 350 provides power for operating each component and provides power to the particulate matter measuring unit 148 via the interfacing unit 320.

As described above, the computation unit 144 may be configured using the functions of a mobile phone without a separate device.

FIG. 4 is a block diagram illustrating a configuration of a particulate matter measuring unit of an individual measuring terminal according to an embodiment of the present invention.

Referring to FIG. 4, according to an embodiment of the present invention, a particulate matter measuring unit 148 of an individual measuring terminal includes an air introducing unit 410, a laser emitting unit 420, a light collecting unit 430, and an interfacing unit 440.

The air introducing unit 410 sucks in an air inlet and an air outlet and introduces particulate matter-containing air. The air introducing unit 410 sucks in the air and passes the air through the laser emitting unit 420, so that the particulate matter-containing air passes through the laser beam from the laser emitting unit.

The laser emitting unit 420 emits a laser beam to the air passing through the air introducing unit 410. The laser emitting unit 420 includes a laser diode and radiates laser beams to the air. The laser emitting unit 420 emits a laser beam to the air, so that the laser beam is scattered by the particulate matter in the air.

The light collecting unit 430 collects and detects the light scattered by the particulate matter. The strength of the scattered light varies depending on the kind and size of the particulate matter. The computation unit 144, although able to measure the light collected by the light collecting unit 430, may have difficulty in grasping the components of the particulate matter. Thus, the light collecting unit 430 may measure the strength of the scattered light or the number of the fine particles per size and provide the measurement to the computation unit 144 or may compute the concentration of particulate matter using a weight factor preset for the measured strength of scattered light or the measured number of fine particles and provide the computed particulate matter concentration to the computation unit 144 via the interfacing unit.

The interfacing unit 440 is connected with the computation unit 144 to receive power from the computation unit 144 and provide the results of measurement and computation by the light collecting unit to the computation unit 144.

The particulate matter measuring unit 148 measures the particulate matter concentration using the light collecting unit 430 and provides the particulate matter concentration measurement to the computation unit 144 to compute an accurate particulate matter concentration. Since the result of measurement is corrected into the accurate particulate matter concentration by the computation unit 144, the particulate matter measuring unit 148 may have only components for measuring the concentration of particulate matter using a general light scattering method, but without the need for an additional component or algorithm for raising the accuracy of the measured concentration or processing the measured concentration.

Further, since the particulate matter measuring unit 148 receives power from the computation unit 144 via the interfacing unit 440, there is no need for a separate power source for operating each component (e.g., the air introducing unit, laser emitting unit, and light collecting unit).

Thus, the particulate matter measuring unit 148 may be implemented in a compact size and reduced cost.

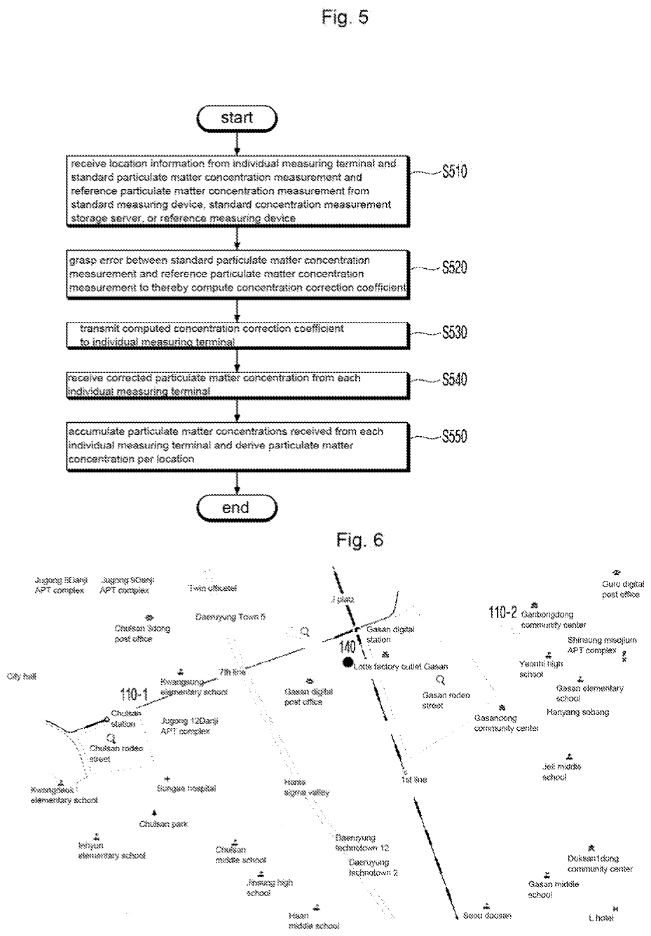

FIG. 5 is a flowchart illustrating a method of computing the concentration of particulate matter by a particulate matter concentration computation server according to an embodiment of the present invention.

The particulate matter concentration computation server 130 receives location information from the individual measuring terminal 140 and a standard particulate matter concentration measurement and reference particulate matter concentration measurement from the standard measuring device 110, standard concentration measurement storage server 115, or reference measuring device 120 (S510). The particulate matter concentration computation server 130 may receive the standard particulate matter concentration measurement and reference particulate matter concentration measurement from the standard measuring device 110 or standard concentration measurement storage server 115 and the reference measuring device 120, respectively, or may receive all the measurements from the reference measuring device 120. Further, the particulate matter concentration computation server 130 may receive the identifier of each measuring device from the standard measuring device 110 or the reference measuring device 120. The particulate matter concentration computation server 130 previously stores the identifiers and locations of the standard measuring device and reference measuring device and stores location information received from the individual measuring terminal.

The particulate matter concentration computation server 130 grasps an error between the standard particulate matter concentration measurement and the reference particulate matter concentration measurement to thereby compute a concentration correction coefficient (S520). The particulate matter concentration computation server 130 selects one or more standard measuring devices 110 and reference measuring devices 120 considering location, atmospheric or weather information along with the location information about the individual measuring terminal 140. The particulate matter concentration computation server 130 grasps an error from the standard particulate matter concentration measurement from the selected standard measuring device 110 and the reference particulate matter concentration measurement from the reference measuring device 120 and computes a concentration correction coefficient.

The particulate matter concentration computation server 130 transmits the computed concentration correction coefficient to the individual measuring terminal 140 (S530).

The particulate matter concentration computation server 130 receives a corrected particulate matter concentration from each individual measuring terminal (S5400. It is also possible to receive the corrected particulate matter concentration or prior-correction particulate matter concentration from the individual measuring terminal.

The particulate matter concentration computation server 130 accumulates the particulate matter concentrations received from each individual measuring terminal and derives the particulate matter concentration per location (S550). The particulate matter concentration computation server 130 receives the corrected particulate matter concentration or non-corrected particulate matter concentration from each individual measuring terminal and stores the particulate matter concentration, corresponding to the location information about each individual measuring terminal. The particulate matter concentration computation server 130 derives the particulate matter concentration per location, using the accumulated particulate matter concentrations.

Although FIG. 5 illustrates that the steps are sequentially performed, this merely provides an embodiment of the disclosure. It would readily be appreciated by a skilled artisan that the steps of FIG. 5 are not limited to the order shown but may rather be performed in a different order, one or more of the steps may simultaneously be performed, or other various modifications or changes may be made thereto without departing from the scope of the disclosure

The steps or processes described above in connection with FIG. 5 may be implemented as computer-readable code in a recording medium. The computer-readable recording medium includes all types of recording devices storing data readable by a computer system. The computer-readable recording medium includes a storage medium, such as a magnetic storage medium (e.g., a ROM, a floppy disk, or a hard disk), an optical reading medium (e.g., a CD-ROM or a DVD), or a carrier wave (e.g., transmission over the Internet). Further, the computer-readable recording medium may be distributed to computer systems connected via a network, and computer-readable codes may be stored and executed in a distributed manner.

The above-described embodiments are merely examples, and it will be appreciated by one of ordinary skill in the art various changes may be made thereto without departing from the scope of the present invention. Accordingly, the embodiments set forth herein are provided for illustrative purposes, but not to limit the scope of the present invention, and should be appreciated that the scope of the present invention is not limited by the embodiments. The scope of the present invention should be construed by the following claims, and all technical spirits within equivalents thereof should be interpreted to belong to the scope of the present invention.

The instant patent application claims priority under 35 U.S.C. 119(a) to Korean Patent Application No. 10-2017-0132563, filed on Oct. 12, 2017, in the Korean Intellectual Property Office, the disclosure of which is herein incorporated by reference in its entirety. The present patent application claims priority to other applications to be filed in other countries, the disclosures of which are also incorporated by reference herein in their entireties.

1. A device of computing a concentration of particulate matter, providing a particulate matter correction constant to allow an individual measuring terminal measuring particulate matter using a light scattering method to measure an accurate particulate matter concentration, comprising:
a communication unit receiving a reference particulate matter concentration measurement from a reference measuring device having the same configuration as the individual measuring terminal or capable of identifying a quantitative correlation with a measurement from the individual measuring terminal, a standard particulate matter concentration measurement from a standard measuring device or the reference measuring device, and location information from the individual measuring terminal and transmitting the particulate matter correction constant to the individual measuring terminal; and
a controller computing the particulate matter correction constant using the reference particulate matter concentration measurement and the standard particulate matter concentration measurement and transmitting the computed particulate matter correction constant to the individual measuring terminal.

2. The device of claim 1, wherein the reference measuring device is placed within a preset range from the standard measuring device.

3. The device of claim 1, further comprising a database storing respective identifiers and locations of the standard measuring device and the reference measuring device, with the identifiers matched with the locations.

4. The device of claim 3, wherein the database stores atmospheric or weather information in the locations of the standard measuring device and the reference measuring device, with the atmospheric or weather information matched with the respective identifiers of the standard measuring device and the reference measuring device.

5. The device of claim 1, wherein the communication unit receives the reference particulate matter concentration measurement or the standard particulate matter concentration measurement, along with an identifier of the reference measuring device or the standard measuring device, from the reference measuring device or the standard measuring device.

6. A method of computing, by a particulate matter concentration computing device, a concentration of particulate matter, for providing a particulate matter correction constant to allow an individual measuring terminal measuring particulate matter using a light scattering method to measure an accurate particulate matter concentration, the method comprising:
receiving a reference particulate matter concentration measurement from a reference measuring device having the same configuration as the individual measuring terminal or capable of identifying a quantitative correlation with a measurement from the individual measuring terminal and a standard particulate matter concentration measurement from a standard measuring device or the reference measuring device;
computing the particulate matter correction constant using the reference particulate matter concentration measurement and the standard particulate matter concentration measurement; and
transmitting the computed particulate matter correction constant to the individual measuring terminal.

7. The method of claim 6, wherein the reference measuring device is placed within a preset range from the standard measuring device.

8. The method of claim 6, wherein the receiving receives the reference particulate matter concentration measurement or the standard particulate matter concentration measurement, along with an identifier of the reference measuring device or the standard measuring device, from the reference measuring device or the standard measuring device.

9. The method of claim 6, further comprising storing respective identifiers and locations of the standard measuring device and the reference measuring device, with the identifiers matched with the locations.

10. The method of claim 9, wherein the storing stores atmospheric or weather information in the locations of the standard measuring device and the reference measuring device, with the atmospheric or weather information matched with the respective identifiers of the standard measuring device and the reference measuring device.

11. A particulate matter measuring terminal measuring a concentration of particulate matter using a light scattering method, comprising:
a power unit supplying power to each component in the particulate matter measuring terminal;
a communication unit receiving, from a particulate matter concentration computation server, a particulate matter concentration correction constant computed using a reference particulate matter concentration measurement from a reference measuring device having the same configuration as the particulate matter measuring terminal or capable of identifying a quantitative correlation with a measurement from the particulate matter measuring terminal and a standard particulate matter concentration measurement from a standard measuring device;
a particulate matter measuring unit measuring the concentration of particulate matter using the light scattering method; and
a controller computing an accurate particulate matter concentration by correcting the particulate matter concentration measured by the particulate matter measuring unit using the particulate matter concentration correction constant.

12. The particulate matter measuring terminal of claim 11, further comprising a positioning unit measuring a location of the particulate matter measuring terminal to compute the particulate matter concentration correction constant using the standard measuring device and reference measuring device located closest to the particulate matter measuring terminal when the particulate matter concentration computation server computes the particulate matter concentration correction coefficient.
